(19) United States
(12) Patent Application Publication
(10) Pub. No.: US 2023/0419946 A1
(43) Pub. Date: Dec. 28, 2023

(54) SOUND GENERATION DEVICE AND CONTROL METHOD THEREOF, PROGRAM, AND ELECTRONIC MUSICAL INSTRUMENT

(71) Applicant: Yamaha Corporation, Hamamatsu (JP)

(72) Inventor: Tatsuya IRIYAMA, Hamamatsu (JP)

(21) Appl. No.: 18/463,470

(22) Filed: Sep. 8, 2023

Related U.S. Application Data
(63) Continuation of application No. PCT/JP2021/046585, filed on Dec. 16, 2021.

(30) Foreign Application Priority Data
Mar. 9, 2021 (JP) 2021-037651

(51) Int. Cl. G10L 13/033; G10H 1/00; G10H 1/36

(52) U.S. Cl. CPC G10L 13/0335; G10H 1/0008; G10H 1/361; G10H 2210/005; G10H 2210/331; G10H 2210/051

(57) ABSTRACT

A sound generation device includes an electronic controller including at least one processor. The electronic controller is configured to execute a first acquisition module configured to acquire first lyrics data in which a plurality of characters to be vocalized are arranged in a time series and that include a first character and a second character that follows the first character, a second acquisition module configured to acquire a vocalization start instruction, and a control module configured to, in response to the acquiring of the vocalization start instruction, output an instruction to generate an audio signal based on a first vocalization corresponding to the first character, in response to the vocalization start instruction satisfying a first condition, and output an instruction to generate the audio signal based on a second vocalization corresponding to the second character, in response to the vocalization start instruction not satisfying the first condition.

### CROSS-REFERENCE TO RELATED APPLICATIONS

This application is a continuation application of International Application No. PCT/JP2021/046585, filed on Dec. 16, 2021, which claims priority to Japanese Patent Application No. 2021-037651 filed in Japan on Mar. 9, 2021. The entire disclosures of International Application No. PCT/JP2021/046585 and Japanese Patent Application No. 2021-037651 are hereby incorporated herein by reference.

### BACKGROUND

### Technological Field

This disclosure relates to a sound generation device and its control method, a program, and an electronic musical instrument.

### Background Technology

In electronic musical instruments such as electronic keyboard devices, besides generating electronic sounds assuming the sounds of musical instruments, singing sounds are also synthesized and generated. Such singing sounds (hereinafter referred to as synthesized singing sounds, as distinguished from actual singing) synthesize a waveform so as to have a designated pitch while combining segments of speech according to characters, such as of lyrics; in this way, a synthesized sound is produced as if the characters were vocalized. Conventionally, a technology for generating synthesized singing sounds by combining a musical score (sequence data, etc.) prepared in advance with characters has been used; however, as described in Patent Japanese Laid-Open Patent Application No. 2016-206496 and Japanese Laid-Open Patent Publication No. 2014-98801, for the performance operations on an electronic keyboard device in response to this, a technology has also been developed to generate synthesized singing sounds in real time.

### SUMMARY

When a conventional singing sound synthesizer automatically advances one character or one syllable at a time in response to the depression of a key of an electronic keyboard device, if a wrong key is struck or if there is a grace note, the position of the lyrics sometimes advances ahead of the performance. If the position of the lyrics gets ahead of the performance, the position of the lyrics and the performance do not match, resulting in an audibly unnatural synthesized singing sound.

Therefore, an object of this disclosure is to generate audibly natural synthesized singing sounds when singing sounds are vocalized in a real-time performance.

In order to realize the object described above, this disclosure provides a sound generation device comprising an electronic controller including at least one processor. The electronic controller is configured to execute a plurality of modules including a first acquisition module configured to acquire first lyrics data in which a plurality of characters to be vocalized are arranged in a time series and which include at least a first character and a second character that follows the first character, a second acquisition module configured to acquire a vocalization start instruction, and a control module configured to, in response to the second acquisition module acquiring the vocalization start instruction, output an instruction to generate an audio signal based on a first vocalization corresponding to the first character of the first lyrics data in response to the vocalization start instruction satisfying a first condition, and output an instruction to generate an audio signal based on a second vocalization corresponding to the second character of the first lyrics data in response to the vocalization start instruction not satisfying the first condition.

### BRIEF DESCRIPTION OF THE DRAWINGS

FIG. 1 is a block diagram showing the configuration of a karaoke system in an embodiment of this disclosure.

FIG. 2 is a block diagram showing the configuration of an electronic musical instrument in an embodiment of this disclosure.

FIG. 3 is a diagram explaining the first lyrics data in an embodiment of this disclosure.

FIG. 4 is a flowchart explaining the sound generation process in an embodiment of this disclosure.

FIG. 5 is a flowchart explaining the instruction process.

FIG. 6 is a diagram showing the relationship between time and pitch in a sound generation process.

FIG. 7 is a diagram showing the relationship between time and pitch in a sound generation process.

FIG. 8 is a diagram showing the relationship between time and pitch in a sound generation process.

FIG. 9 is a functional block diagram showing the sound generation function in an embodiment of this disclosure.

FIG. 10 is a flowchart explaining the instruction process.

FIG. 11 is a diagram showing the relationship between time and pitch in a sound generation process.

FIG. 12 is a diagram explaining the first lyrics data in an embodiment of this disclosure.

FIG. 13 is a diagram showing the relationship between time and pitch in a sound generation process.

FIG. 14 is a diagram explaining the second lyrics data in an embodiment of this disclosure.

FIG. 15 is a diagram showing the relationship between time and pitch in a sound generation process.

FIG. 16 is a diagram showing the configuration of an electronic wind instrument in an embodiment of this disclosure.

### DETAILED DESCRIPTION OF THE EMBODIMENTS

A karaoke system according to an embodiment of this disclosure will be described in detail below with reference to the drawings. The following embodiments are examples of embodiments of this disclosure, but the invention is not limited to these embodiments.

### First Embodiment

### Overall Structure

The karaoke system according to an embodiment of this disclosure has a function for generating natural synthesized singing sounds when the singing sounds are vocalized in a real-time performance by specifying a target musical piece when karaoke is performed using an electronic musical instrument that can generate synthesized singing sounds.

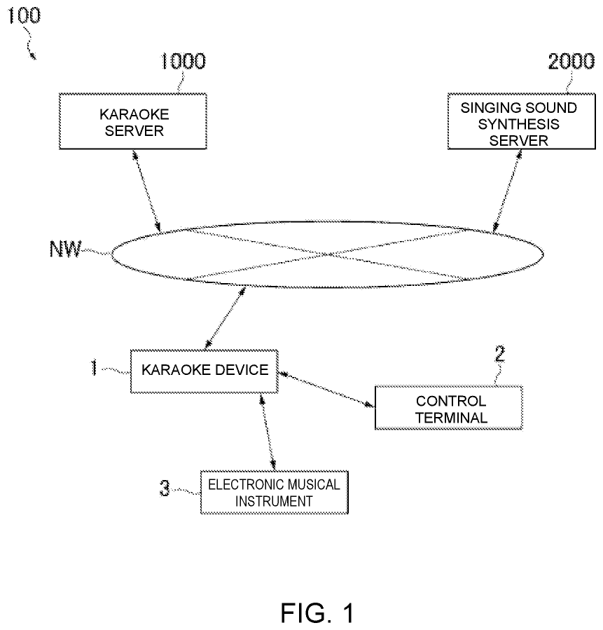

FIG. 1 is a block diagram showing the configuration of a karaoke system in an embodiment of this disclosure. A karaoke system 100 comprises a karaoke device 1, a control terminal 2, an electronic musical instrument 3 (sound generation device), a karaoke server 1000, and a singing sound synthesis server 2000. In this example, the karaoke device 1, the karaoke server 1000, and the singing sound synthesis server 2000 are interconnected via a network NW, such as the Internet. In this example, the karaoke device 1 is connected to the control terminal 2 and to the electronic musical instrument 3 by short-range wireless communication, but can also be connected by communication via the network NW. Short-range wireless communication is, for example, communication utilizing Bluetooth (registered trademark), infrared communication, a LAN (Local Area Network), etc.

The karaoke server 1000 is equipped with a storage device that stores music data required for providing karaoke in the karaoke device 1 in association with song IDs. Song data include data pertaining to karaoke songs, such as lead vocal data, chorus data, accompaniment data, and karaoke subtitle data. Lead vocal data indicate the main melody part of a song. Chorus data indicate secondary melody parts, such as harmony to the main melody. Accompaniment data indicate accompaniment sounds of the song. The lead vocal data, chorus data, and accompaniment data can be expressed in MIDI format. The karaoke subtitle data are data for displaying lyrics on the display of the karaoke device 1.

The singing sound synthesis server 2000 is equipped with a storage device for storing setting data for setting the electronic musical instrument 3 in accordance with the song, in association with the song IDs. Setting data include lyrics data corresponding to each part of the song to be sung corresponding to the song ID. Lyrics data corresponding to the lead vocal part are referred to as first lyrics data. First lyrics data stored in the singing sound synthesis server 2000 can be the same as or different from the karaoke subtitle data stored in the karaoke server 1000. That is, the first lyrics data stored in the singing sound synthesis server 2000 are the same in that the data are data that define the lyrics (characters) to be vocalized, but are adjusted to a format that can easily be used in the electronic musical instrument 3. For example, karaoke subtitle data stored in the karaoke server 1000 are character strings such as “ko,” “n,” “ni,” “chi,” and “ha.” In contrast, the first lyrics data stored in the singing sound synthesis server 2000 can be character strings that match the actual pronunciations of “ko,” “n,” “ni,” “chi,” and “wa” for easy use by the electronic musical instrument 3. This format can include information for identifying cases in which two characters are sung with one sound, information for identifying breaks in phrases, and the like.

The karaoke device 1 includes an input terminal to which an audio signal is supplied and a speaker that outputs the audio signal as sound. The audio signal input to the input terminal can be supplied from the electronic musical instrument 3 or from a microphone.

The karaoke device 1 reproduces the audio signal from the accompaniment data of the music data received from the karaoke server 1000, and outputs the audio signal from the speaker as an accompaniment sound of the song. The sound corresponding to the audio signal supplied to the input terminal can be synthesized with the accompaniment sound and output.

The control terminal 2 is a remote controller that transmits user instructions (for example, song designation, volume, transpose, etc.) to the karaoke device 1. The control terminal 2 can also transmit user instructions (for example, setting of the lyrics, timbre, etc.) to the electronic musical instrument 3 via the karaoke device 1.

In the karaoke system, the control terminal 2 transmits an instruction for setting the musical piece set by the user to the karaoke device 1. Based on this instruction, the karaoke device 1 acquires the music data of the musical piece from the karaoke server 1000 and first lyrics data from the singing sound synthesis server 2000. The karaoke device 1 transmits the first lyrics data to the electronic musical instrument 3. The first lyrics data are stored in the electronic musical instrument 3. Based on the user's instruction to start the performance of the musical piece, the karaoke device 1 reads the music data and outputs the accompaniment sound, etc., and the electronic musical instrument 3 reads the first lyrics data and outputs a synthesized singing sound in accordance with the user's performance operation. Hardware configuration of the electronic musical instrument

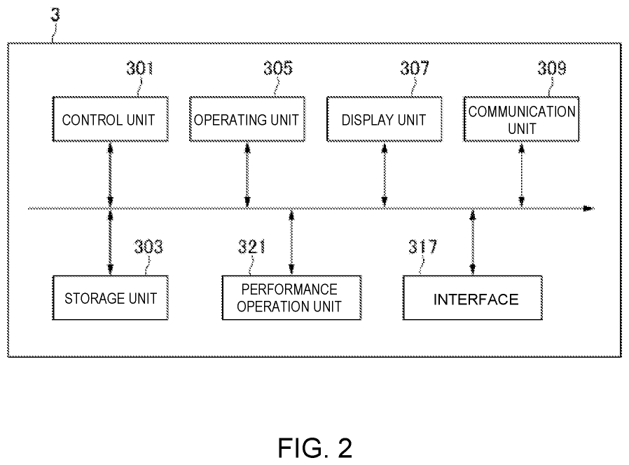

The electronic musical instrument 3 is a device that generates an audio signal representing a synthesized singing sound in accordance with the contents of an instruction in response to an operation of a performance operation unit 321 (FIG. 2). In the present embodiment, the electronic musical instrument 3 is an electronic keyboard device. The performance operation unit 321 includes a keyboard comprising a plurality of keys (one example of) and a sensor for detecting operations of each key (hereinafter also referred to as performance operation). In the present embodiment, the synthesized singing sound can be output from the speaker of the karaoke device 1 when an audio signal is supplied from the electronic musical instrument 3 to the input terminal of the karaoke device 1, or from a speaker connected to the electronic musical instrument 3.

FIG. 2 is a block diagram showing the configuration of the electronic musical instrument 3 in the embodiment of this disclosure. The electronic musical instrument 3 includes a control unit (electronic controller) 301, a storage unit 303, an operating unit 305, a display unit 307, a communication unit 309, an interface 317, and the performance operation unit 321. Each of these components are interconnected via a bus.

The control unit 301 is an electronic controller that includes one or a plurality of processors. In this embodiment, the control unit 301 includes an arithmetic processing circuit, such as a CPU (Central Processing Unit). The term “electronic controller” as used herein refers to hardware that executes software programs. The control unit 301 causes the CPU to execute programs stored in the storage unit 303 to realize various functions in the electronic musical instrument 3. The functions realized in the electronic musical instrument 3 include, for example, a sound generation function for executing a sound generation process. The control unit 301 can be configured to comprise, instead of the CPU or in addition to the CPU, an MPU (Microprocessing Unit), a GPU (Graphics Processing Unit), an ASIC (Application Specific Integrated Circuit), an FPGA (Field Programmable Gate Array), a DSP (Digital Signal Processor), and a general-purpose computer. Moreover, the electronic controller can include a plurality of CPUs. In this embodiment, the control unit 301 further includes the DSP for generating audio signals by the sound generation function. The control unit 301 (electronic controller) is configured to execute a plurality of modules including at least a first acquisition module (lyrics data acquisition unit 31), a second acquisition module (vocalization start instruction acquisition unit 34), and a control module (vocalization control unit 32) as explained below.

The storage unit 303 is a storage device (memory (computer memory)) such as non-volatile memory. The storage unit 303 is one example of a non-transitory computer-readable medium. The storage unit 303 stores a program for realizing the sound generation function described above. The sound generation function will be described further below. The storage unit 303 also stores setting information used in generating audio signals representing the synthesized singing sound, segments of speech for generating the synthesized singing sound, and the like. Setting information includes, for example, timbre, as well as the first lyrics data received from the singing sound synthesis server 2000.

The operating unit 305 is a device (user operable input(s)) such as a switch, volume knob, etc., and outputs a signal to the control unit 301 in response to the input operations. The display unit 307 is a display device (display), such as a liquid-crystal display or an organic EL display, which displays a screen based on control by the control unit 301. The operating unit 305 and the display unit 307 can be integrated to form a touch panel. The communication unit (communication device) 309 connects to the control terminal 2 by short-range wireless communication based on the control by the control unit 301. The term “communication device” as used herein includes a receiver, a transmitter, a transceiver and a transmitter-receiver, capable of transmitting and/or receiving signals over the telephone, other communication wire, or wirelessly.

The performance operation unit 321 outputs performance signals to the control unit 301 in response to the performance operation. The performance operation unit 321 includes a plurality of user operable keys (for example, the plurality of keys) and a sensor that detects one or more operations of each operable key. Performance signals include information indicating the position of the operated key (note number), information indicating that a key has been pressed (note on), information indicating that a key has been released (note off), key depression speed (velocity), and the like. Specifically, when a key is pressed, a note on, which is associated with the velocity and note number (also called pitch instruction) is output as a performance signal indicating a vocalization start instruction, and when the key is released, a note off, which is associated with the note number, is output as a performance signal indicating a vocalization stop instruction. The control unit 301 uses these performance signals to generate audio signals. The interface 317 includes a terminal for outputting the generated audio signals.

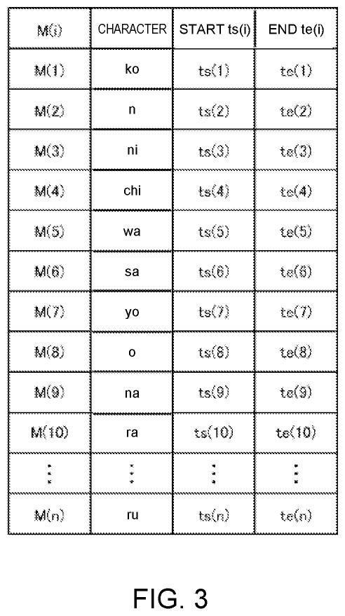

Here, an example of the first lyrics data stored in the storage unit 303 will be described with reference to FIG. 3. FIG. 3 shows the first lyrics data used in the embodiment of this disclosure. The first lyrics data are data that define the lyrics (characters) to be vocalized. The first lyrics data include text data in which a plurality of characters to be vocalized are arranged in chronological order. The first lyrics data include timing data that define the start and stop times of vocalization for each character on a prescribed time axis. The start and stop times are defined as times related to the beginning of the song, for example. These timing data associate a progression position of the song and the lyrics to be vocalized at the progression position.

Hereinafter, each of the lyrics (characters) to be vocalized, that is, a unit (a group of divided sounds) of speech can be referred to as a “syllable.” In the present embodiment, “character” in the lyrics data (including second lyrics data described further below) is used synonymously with “syllable.”

As shown in FIG. 3, the first lyrics data include text data representing “ko,” “n,” “ni,” “chi,” “wa,” “sa,” “yo,” “o,” “na,” and “ra.” The characters “ko,” “n,” “ni,” “chi,” “wa,” “sa,” “yo,” “o,” “na,” and “ra” are associated with M(i), and the “i” (i=1˜n) set the order of the characters in the lyrics. For example, M(5) corresponds to the 5th character in the lyrics. The first lyrics data include timing data in which a vocalization start time ts(i) and stop time te(i) are set for each character M(i). For example, in the case of M(1) “ko,” the vocalization start time is time ts(1), and the stop time is time te(1). Similarly, in the case of M(n) “ru,” the vocalization start time is time ts(n), and stop time is time te(n). The interval (period) between times ts(i) and te(i) corresponding to each character M(i) is referred to as the vocalization setting interval (vocalization setting period) of the character M(i). This vocalization setting interval indicates the time interval in the case of ideal singing, for example. As described below, the vocalization interval of each character included in the synthesized singing sound is controlled based on the vocalization start instruction and the vocalization stop instruction by the performance signal, and thus is unrelated to the vocalization setting interval defined in the timing data.

### Sound Generation Process

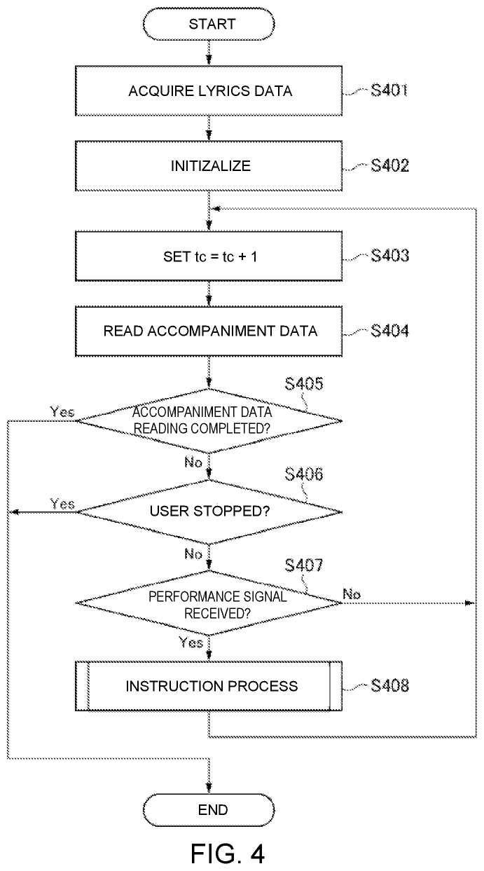

The sound generation process according to the embodiment of this disclosure will now be described with reference to FIGS. 4-8. The sound generation process outputs an instruction to generate or stop an audio signal corresponding to the vocalization of each character based on the performance operation on the performance operation unit 321.

FIG. 4 is a flowchart explaining the sound generation process in the embodiment of this disclosure. This process is realized by the CPU of the control unit 301 deploying a program stored in the storage unit 303 in the RAM of the storage unit 303 and executing the program. This process is initiated, for example, when the user gives an instruction to play the musical piece.

When the process is initiated by the user's instruction to play the musical piece, the control unit 301 obtains the first lyrics data from the storage unit 303 (Step S401). The control unit 301 then performs an initialization process (Step S402). In the present embodiment, initialization means that the control unit 301 sets the count value tc=0. The control unit 301 then sets count value tc=tc+1, thereby incrementing the count value tc (Step S403). Next, of the accompaniment data, the data of the portion corresponding to the count value tc are read (Step S404).

The control unit 301 waits until the end of the reading of the accompaniment data, the input of a user instruction to stop the performance of the musical piece, or the reception of a performance signal is detected (Step S405: NO, Step S406: NO, Step S407: NO) and repeats the processing in Steps S403 and S404 until the above-described detection is made. This state is referred to as the standby state. As described above, the initial value of the count value tc is 0, which corresponds to the playback start timing of the musical piece. The control unit 301 increments the count value tc to measure a time based on the playback start timing of the musical piece.

When the reading of the accompaniment data has been completed by reading the accompaniment data to the end of the standby state (Step S405: YES), the control unit 301 terminates the sound generation process. If the user inputs an instruction to stop the performance of the musical piece in the standby state (Step S406: YES), the control unit 301 terminates the sound generation process.

If a performance signal is received from the performance operation unit 321 in the standby state (Step S407: YES), the control unit 301 executes an instruction process for generating an audio signal by the DSP (Step S480). A detailed explanation of the instruction process for generating an audio signal will be described further below. When the instruction process for generating an audio signal is completed, the process again proceeds to Step S403, and the control unit 301 enters the standby state to repeat the processing of steps 403 and 404.

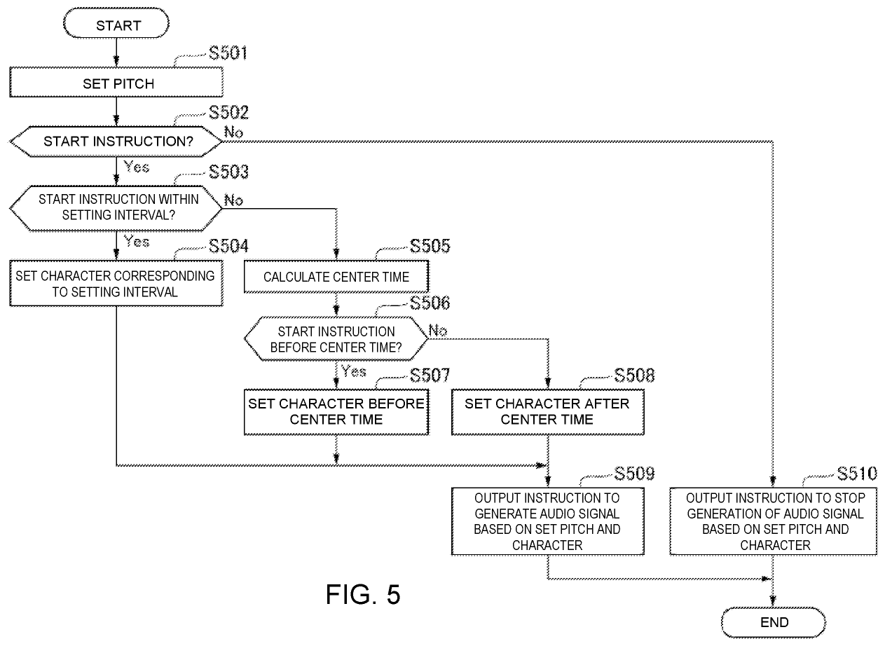

FIG. 5 is a flowchart showing the instruction process executed in Step S480 of FIG. 4.

When a performance signal is received from the performance operation unit 321, the instruction process for generating an audio signal is initiated. First, the control unit 301 sets the pitch based on the performance signal obtained from the performance operation unit 321 (Step S501). The control unit 301 determines whether the performance signal acquired from the performance operation unit 321 is a vocalization start instruction (Step S502).

If it is determined that the performance signal is a vocalization start instruction (Step S502: YES), the control unit 301 determines whether the count value tc at the time that the vocalization start instruction was acquired is within the vocalization setting interval corresponding to any one of the characters by referring to the first lyrics data.

If it is determined that the time that the vocalization start instruction was acquired is within the vocalization setting interval corresponding to one of the characters M(i) (Step S503: YES), the control unit 301 sets the character M(p) corresponding to said vocalization setting interval as the character to be vocalized (Step S504). The control unit 301 then outputs an instruction to the DSP to generate an audio signal based on the vocalization of the character M(p) at the set pitch (Step S509), terminates the instruction process, and proceeds to Step S403 shown in FIG. 4.

If the control unit 301 determines that the time at which the vocalization start instruction was acquired is not within the vocalization setting interval for any character (Step S503: NO), the control unit 301 calculates a center time tm(q) between a vocalization stop time te(q) corresponding to the immediately preceding character M(q) with respect to the time of the vocalization start instruction, and a vocalization start time ts(q+1) corresponding to the next character M(q+1) (Step S505). If it is assumed that the stop time te(q) is a “first time” and the start time ts(q+1) is a “second time,” the center time between the stop time te(q) and the start time ts(q+1) is called a “third time.” If the count value tc is in the interval between the vocalization stop time te(1) of “ko” (character M(1)) and the vocalization start time ts(2) of “n” (character M(2)), the control unit 301 calculates the center time tm(1)=(te(1)+ts(2))/2. If the center time tm(q) between the immediately preceding vocalization stop time te(q) and the next vocalization start time ts(q+1) is calculated in advance, Step S505 can be omitted. The control unit 301 then determines whether the count value tc is before the center time tm(q) (Step S506). Here, determining whether the count value tc is before the center time tm(q) is one example of determining whether a “first condition” is satisfied.

If the count value tc is before the center time tm(q) (Step S506: YES), the control unit 301 sets a character M(q) corresponding to the set interval before the center time tm(q) (S507). The control unit 301 then outputs an instruction to the DSP to generate an audio signal based on the vocalization of the character M(q) at the set pitch (Step S509), terminates the instruction process, and proceeds to Step S403 shown in FIG. 4.

If the obtained start instruction is not before the center time tm(q) (Step S506: NO), the control unit 301 reads the character M(q+1) corresponding to the set interval after the center time tm(q) (Step S508). The control unit 301 then outputs a signal to start the vocalization of the character at the acquired pitch (Step S509), terminates the instruction process, and proceeds to Step S403 shown in FIG. 4.

If it is determined that the performance signal acquired from the performance operation unit 321 is not a vocalization start instruction, that is, that it is a vocalization stop instruction (Step S502: NO), the control unit 301 outputs an instruction to the DSP to stop the generation of the audio signal generated based on the vocalization of the character M(q) at the set pitch (Step S510), terminates the instruction process, and proceeds to Step S403 shown in FIG. 4.

In summary, the instruction process described above can be rephrased as follows. In the instruction process for generating an audio signal, the control unit 301 determines whether the vocalization start instruction satisfies the first condition. If the first condition is satisfied, the control unit 301 generates an audio signal based on the first vocalization corresponding to the first character, and if the first condition is not satisfied, generates an audio signal based on the second condition corresponding to the second character after the first character. In the present embodiment, the first condition is a condition in which the time that the vocalization start instruction is acquired is before the center time between the stop time of the first character and the start time of the second character. To further rephrase the instruction process described above, the control unit 301 identifies the setting interval to which the acquisition time of the vocalization start instruction belongs, or the setting interval that is closest to the acquisition time, and generates an audio signal based on the vocalization corresponding to the character corresponding to the identified setting interval.

In this manner, by sequential processing, a synthesized singing sound is generated in which the characters of the song lyrics, which are identified with the progression of the accompaniment sound from the playback of the accompaniment sound data, are sequentially vocalized at the timing and pitch corresponding to the performance operation. An audio signal representing the synthesized singing sound is then output to the karaoke device 1.

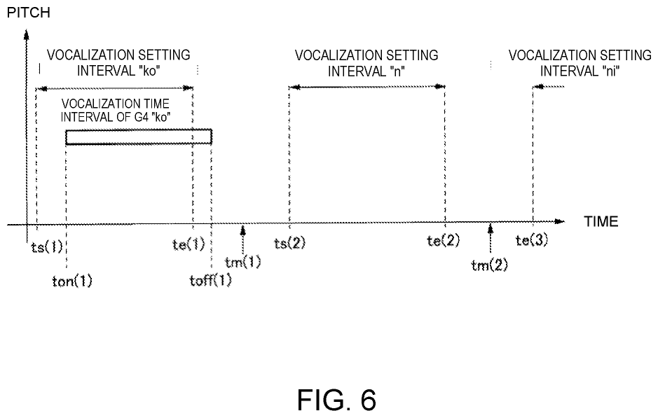

A specific example of the sound generation process shown in FIGS. 4 and 5 will now be described with reference to FIGS. 6-8. FIGS. 6-8 are diagrams showing the relationship between time and pitch in the sound generation process.

First, a case in which the count value tc (acquisition time) when the vocalization start instruction was acquired is within the setting interval ts(1)-te(1) of the vocalization will be explained with reference to FIG. 6. A case is assumed in which, in the standby state of the sound generation process, the control unit 301 receives a performance signal from the performance operation unit 321 that includes a vocalization start instruction associated with the pitch “G4.” In this case, the control unit 301 executes the instruction process (Step S408) and sets the pitch “G4” based on the performance signal (Step S501). The control unit 301 determines that the performance signal is a vocalization start instruction (Step S502: NO), refers to the first lyrics data shown in FIG. 3, and determines whether the count value tc when the start instruction was acquired is included in (belongs to) the vocalization setting interval (Step S503). Since the time at which the vocalization start instruction was acquired is within the setting interval ts(1)-te(1), the control unit 301 determines that the time at which the start instruction was acquired is included in the vocalization setting interval corresponding to the character M(1) (Step S503: YES) and sets the character “ko” corresponding to the character M(1) as the character to be vocalized (Step S504). The control unit 301 then outputs an instruction to the DSP to generate an audio signal based on the vocalization of the character “ko” at the set pitch “G4” (Step S509). In FIG. 6, the time at which the instruction for generating an audio signal based on the vocalization of the character “ko” at the set pitch “G4” is output to the DSP is written as time ton(1). The DSP of the control unit 301 starts the generation of the audio signal based on this instruction.

Next, a case will be explained in which, in the standby state of the sound generation process, a performance signal including a vocalization stop instruction associated with the pitch “G4” is received from performance operation unit 321. In this case, the control unit 301 executes the instruction process (Step S408) and sets the pitch “G4” based on the performance signal (Step S501). The control unit 301 determines that the performance signal is a vocalization stop instruction (Step S502: NO), and the DSP of the control unit 301 outputs an instruction to generate an audio signal based on the vocalization (character “ko”) at the set pitch “G4” (Step S510). In FIG. 6, the time at which the instruction for stopping the generation of an audio signal based on the vocalization of the character “ko” at the set pitch “G4” is output is denoted as time toff(1). The DSP of the control unit 301 stops the generation of the audio signal based on the instruction. In FIG. 6, the vocalization time interval ton(1)-toff(1) is the period in which the audio signal based on the vocalization of character “ko” at the pitch “G4” is generated.

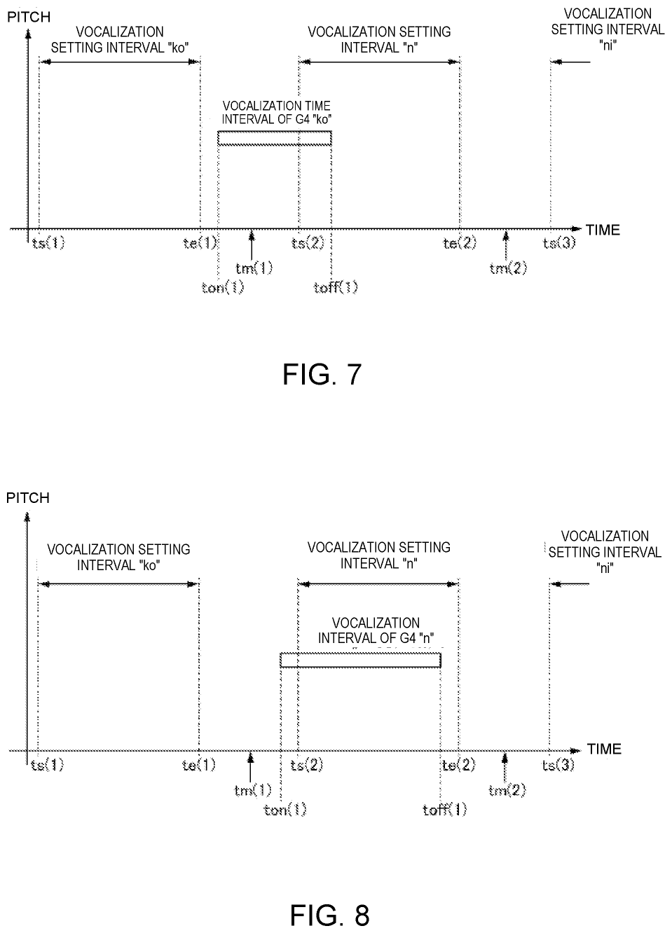

A case in which the count value tc, from when the vocalization start instruction was acquired, is between the setting interval ts(1)-te(1) and the setting interval ts(2)-te(2), and is close to the setting interval ts(1)-te(1), will now be explained with reference to FIG. 7. It is assumed that in the standby state of the sound generation process, the control unit 301 receives a performance signal from the performance operation unit 321 that includes a vocalization start instruction associated with the pitch “G4.” In this case, the control unit 301 executes the instruction process (Step S408) and sets the pitch “G4” based on the performance signal (Step S501). The control unit 301 determines that the performance signal is a vocalization start instruction (Step S502: NO), refers to the first lyrics data shown in FIG. 3, and determines whether the count value tc when the start instruction was acquired is included in the vocalization setting interval (Step S503). Since the time that the start instruction was acquired is not within any of the vocalization setting intervals corresponding to the characters M(i), the control unit 301 determines that the start instruction is not included in any of the vocalization setting intervals (Step S503: NO). The control unit 301 then calculates the center time tm(i) from the setting interval set immediately before and after the count value tc. If the count value tc when the start instruction was acquired is between the setting interval ts(1)-te(1) and the setting interval ts(2)-te(2), the control unit 301 calculates the center time tm(1) between the stop time te(1) and the start time ts(2) (Step S505). Here, tm(1)=(te(1)+ts(2))/2 is obtained. The control unit 301 then determines that the count value tc when the start instruction was acquired is before the center time tm(1) (Step S506: YES), and sets the character “ko” (character M(1)) of the setting interval before the center time tm(1) as the character to be vocalized (Step S507). Instructions to start and stop the generation of the audio signal based on the vocalization of the character “ko” at the pitch “G4” are the same as for the method described in FIG. 6. In FIG. 7, the vocalization time interval ton(1)-toff(1) is the period in which the audio signal based on the vocalization of the character “ko” at the pitch “G4” is generated.

A case in which the count value tc when the vocalization start instruction shown in FIG. 8 was acquired is between the setting interval ts(1)-te(1) and the setting interval ts(2)-te(2), and is close to the setting interval ts(2)-te(2) will be described with reference to FIG. 8. The process from the start of the sound generation process to Step S505 is the same as the process described in FIG. 7, so that its explanation will be omitted. The control unit 301 determines that the time when the start instruction was acquired is not before the center time tm(1) (Step S506: NO) and sets the character “n” (character M(2)) of the setting interval after the center time tm(1) as the character to be vocalized (Step S508). The instructions for starting and stopping the generation of the audio signal based on the vocalization of the character “n” at the pitch “G4” are the same as those for the method described in FIG. 6. In FIG. 8, the interval ton(1)-toff(1) is the period during which the audio signal based on the vocalization of the character “n” at the pitch “G4” is generated.

### Sound Generation Function

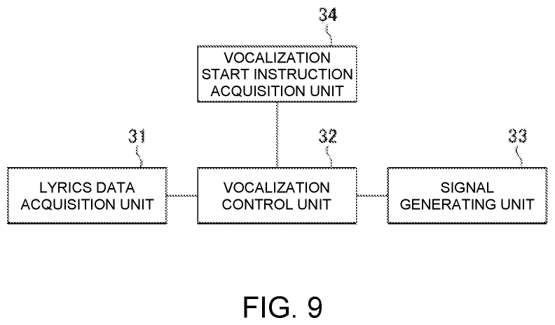

FIG. 9 is a functional block diagram showing the sound generation function in the embodiment of this disclosure. Some or all of the configurations for realizing the functions described below can be realized in hardware.

The electronic musical instrument 3 includes a lyrics data acquisition unit 31 (first acquisition module), a vocalization control unit 32 (control module), a signal generating unit (signal generating module) 33, and a vocalization start instruction acquisition unit 34 (second acquisition module) as functional blocks that realize the sound generation function, etc., for generating the synthesized singing sound. The functions of these functional units are realized by the cooperation of the control unit 301, the storage unit 303, a timer, not shown. It is not essential that the functional blocks include the signal generator 33 of this disclosure.

The lyrics data acquisition unit 31 acquires the first lyrics data corresponding to the song ID from the singing sound synthesis server 2000 via the karaoke device 1. The vocalization control unit 32 primarily executes the instruction process shown in FIG. 5 and outputs an instruction to the signal generating unit 33 to start or stop the generation of an audio signal based on vocalization. The vocalization start instruction acquisition unit 34 acquires the vocalization start instruction. The vocalization start instruction is acquired, for example, as a performance signal that is input by the user via the performance operation unit 321.

The signal generating unit 33 corresponds to the aforementioned DSP and starts or stops the generation of audio signals based on the instruction received from the vocalization control unit 32. The audio signal generated by the signal generating unit 33 is output to the outside via the interface 317.

### Second Embodiment

In the present embodiment, a sound generation process that is somewhat different from the sound generation process described in the first embodiment will be described with reference to FIGS. 4, 10 and 11. In the present embodiment, the instruction process for generating audio signals is different from that of the first embodiment. Therefore, the parts that are different from the first embodiment will be described in detail, and the explanation of the first embodiment will be applied to the other parts. In addition, in the present embodiment, velocity is treated as volume information.

In the present embodiment, in the first lyrics data shown in FIG. 3, characters M(i)=M(1)-M(10) are vocalized in order. That is, in the first lyrics data, the order of vocalization of a plurality of characters is set. Thus, in the first lyrics data shown in FIG. 3, the timing data that defines the vocalization setting interval can be omitted.

In the flowchart shown in FIG. 4, when the process is started as a result of a user instruction to play the musical piece, the control unit 301 acquires the first lyrics data from the storage unit 303 (Step S401). The control unit 301 then performs an initialization process (Step S402). In the present embodiment, initialization means that the control unit 301 sets count value tc=0, in the same manner as in the first embodiment. In the second embodiment, the control unit 301 also sets a character count value i=1(character M(i)=M(1)) at M(i), and sets ts=0, as the initialization process. As described above, “i” indicates the order of a character in the lyrics. In the present embodiment, ts is the time at which the immediately preceding vocalization start instruction was acquired. Thus, with each incrementation of “i,” the control unit 301 advances the character indicated by M(i) among the characters constituting the lyrics by one. The process of the standby state in Steps S403-407 is the same as that in the first embodiment. If a performance signal is received from the performance operation unit 321 in the standby state (Step S407: YES), an instruction process for generating an audio signal is executed (Step S408).

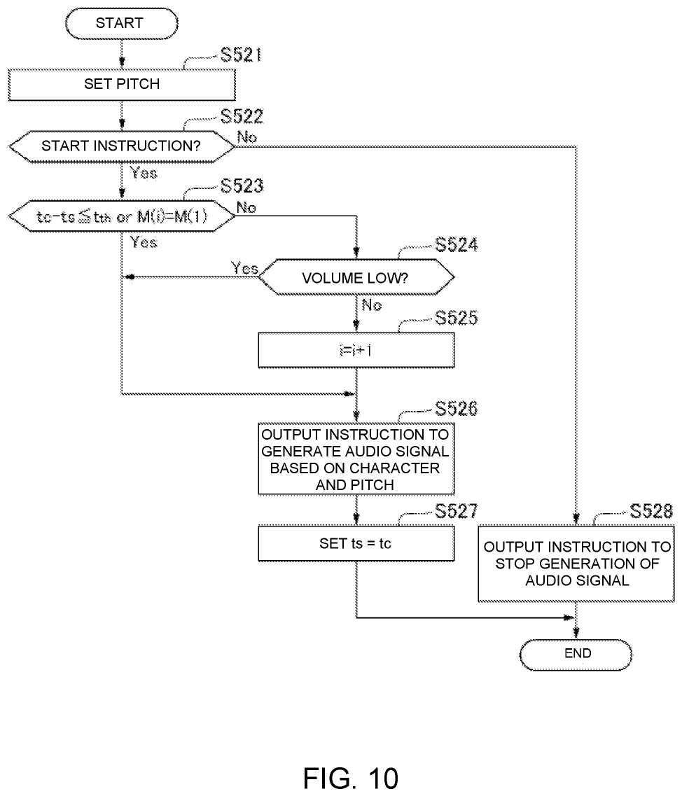

FIG. 10 is a flowchart explaining the instruction process for generating audio signals. This process is executed in Step S408) of FIG. 4.

When a performance signal is received from the performance operation unit 321, the instruction process for generating audio signals is started. First, the control unit 301 sets the pitch based on the performance signal acquired from the performance operation unit 321 (Step S521). The control unit 301 determines whether the performance signal acquired from the performance operation unit 321 is a vocalization start instruction (Step S522).

If it is determined that the performance signal is a vocalization start instruction (Step S522: YES), the control unit 301 determines whether the time ts at which the vocalization start instruction was acquired satisfies tc−ts≤tₜₕ or M(i)=M(1) (Step S523). Here, tc−ts is the elapsed time from the time of the last acquisition of the vocalization start instruction to the present time. tₜₕ is a prescribed time interval. If the time ts satisfies either tc−ts≤tₜₕ or M(i)=M(1) (Step S523: YES), the control unit 301 outputs an instruction to the DSP to generate an audio signal for the character M(i) (Step S526). If M(i)=M(1) is satisfied, i.e., if it is the first vocalization, the control unit 301 sets the character “ko” as the character to be vocalized, and if tc−ts≤tₜₕ is satisfied, the control unit sets the same character as the character set in the immediately preceding vocalization as the character to be vocalized. The control unit 301 then sets the count value tc to time ts (Step S527), terminates the instruction process, and proceeds to Step S403 shown in FIG. 4.

If the time ts satisfies neither tc−ts≤tₜₕ nor M(i)=M(1) (Step S523: NO), the control unit 301 determines whether the volume acquired in the vocalization start instruction is lower than a prescribed volume (Step S524). If the volume acquired in the vocalization start instruction is lower than the prescribed volume (Step S524: YES), the control unit 301 executes Steps S526, 527, then terminates the instruction process and proceeds to the Step S403 shown in FIG. 4. On the other hand, if the volume acquired in the vocalization start instruction is higher than or equal to the prescribed volume (Step S524: NO), the control unit 301 increments the character count value i=i+1 (Step S525). The control unit 301 then outputs an instruction to the DSP to generate an audio signal based on the vocalization of the character set in character count value i=i+1 (Step S526). The control unit 301 then sets the count value tc to time ts (Step S527), terminates the instruction process, and proceeds to the Step S403 shown in FIG. 4.

In the present embodiment, the first condition is whether or not either tc−ts≤tₜₕ or M(i)=M(1) is satisfied. The first condition is also whether or not the volume is lower than a prescribed volume, even if neither tc−ts≤tₜₕ nor M(i)=M(1) is satisfied.

In this manner, by the sequential processing shown in FIGS. 4 and 10, a synthesized singing sound is generated in which the characters of the song lyrics, which are identified with the progression of the accompaniment sound due to the playback of the accompaniment sound data, are sequentially vocalized at a pitch and timing in accordance with the performance operation. An audio signal representing the synthesized singing sound is then output to the karaoke device 1.

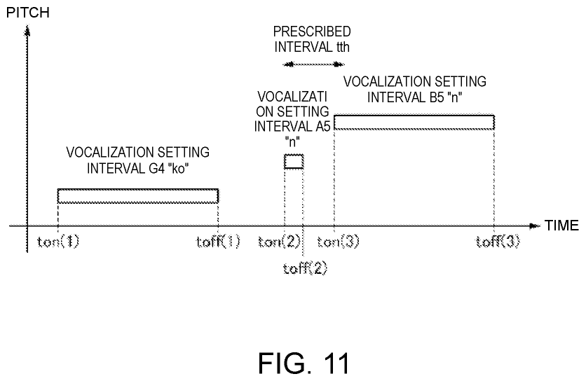

A specific example of the sound generation process shown in FIGS. 4 and 10 will be described with reference to FIG. 11. FIG. 11 is a diagram showing the relationship between time and pitch in the sound generation process. In FIG. 11, the vocalizations of character “ko” at pitch “G4,” of character “n” at pitch “A5,” and character “n” at pitch “B5” are illustrated as syllable notes with pitch information.

When the sound generation process is started, the control unit 301 acquires the first lyrics data (Step S401) and executes the initialization process (Step S402). In the initialization process, the control unit 301 sets character M(i)=M(1), tc=0, and ts=0. A case is assumed in which, in the standby state of the sound generation processing, the control unit 301 receives a performance signal associated with the pitch “G4” from the performance operation unit 321 (Step S407: YES). In this case, the control unit 301 executes the instruction process (Step S408) and sets the pitch “G4” based on the performance signal (Step S521). The control unit 301 determines that the performance signal is a vocalization start instruction (Step S522: YES) and determines whether or not either tc−ts≤tₜₕ or M(i)=M(1) is satisfied (Step S523). The control unit 301 determines that M(i)=1 is satisfied (Step S523: YES). Since the character M(1) is “ko,” the control unit 301 outputs an instruction to the DSP to generate an audio signal based on the vocalization of the character “ko” at the pitch “G4” (Step S526). The control unit 301 sets the count value tc to time ts (Step S527), terminates the instruction process, and proceeds to the Step S403 shown in FIG. 4. In FIG. 11, the time ts at which the instruction for generating an audio signal based on the vocalization of the character “ko” at the set pitch “G4” is output to the DSP is designated as time ton(1). The DSP of the control unit 301 starts the generation of the audio signal based on this instruction.

Next, a case is assumed in which, in the standby process of the sound generation processing, the control unit 301 receives a performance signal associated with the pitch “G4” from the performance operation unit 321. In this case, the control unit 301 executes the instruction process (Step S408) and sets the pitch “G4” based on the performance signal (Step S521). When it is determined that the performance signal is a vocalization stop instruction (Step S522: NO), the control unit 301 outputs an instruction to stop the generation of the audio signal based on the vocalization of the character “ko” at the set pitch G4 (Step S510), terminates the instruction process, and proceeds to the Step S403 shown in FIG. 4. In FIG. 11, the time at which the instruction to stop the generation of audio signal based on the vocalization of the character “ko” at the set pitch “G4” is output to the DSP is designated as time toff(1). The DSP of the control unit 301 stops the generation of the audio signal based on this instruction. In FIG. 11, the interval ton(1)-toff(1) is the period during which the audio signal based on the vocalization of the character “ko” at the pitch “G4” is generated.

Next, a case is assumed in which, in the standby process of the sound generation processing, the control unit 301 receives a performance signal including a vocalization start instruction associated with the pitch “A5” from the performance operation unit 321. In this case, the control unit 301 executes the instruction process (Step S408) and sets the pitch “A5” based on the performance signal (Step S521). The control unit 301 then determines that the performance signal is a vocalization start instruction (Step S522: YES) and determines whether or not either tc−ts≤tₜₕ or M(i)=M(1) is satisfied (Step S523). The prescribed interval tₜₕ is in the range of 10 ms-100 ms, for example, and is 100 ms in the present embodiment. When tc−ts exceeds 100 ms, it is determined that tc−ts≤tₜₕ is not satisfied. Here, since tc−ts is longer than the prescribed interval tₜₕ, the control unit 301 determines that neither tc−ts≤tₜₕ nor M(i)=M(1) is satisfied (Step S523: NO) and determines whether the volume is lower than the prescribed volume (Step S524). When it is determined that the volume is higher than or equal to the prescribed volume (Step S524: NO), the control unit 301 sets the character count value i=i+1 (Step S525). Here, the character M(2) after the character M(1) is set. Since the character M(2) is “n,” the control unit 301 outputs an instruction to the DSP to generate an audio signal based on the vocalization of the character “n” at the pitch “A5” (Step S526). The control unit 301 sets the count value tc to time ts (Step S527), terminates the instruction process, and proceeds to the Step S403 shown in FIG. 4. In FIG. 11, the interval ton(2)-toff(2) is the period during which the audio signal based on the vocalization of the character “n” at the pitch “A5” is generated.

Next, a case is assumed in which, in the standby state of the sound generation process, a performance signal including a vocalization start instruction associated with the pitch “B5” is received from performance operation unit 321. In this case, the control unit 301 executes the instruction process (Step S408) and sets the pitch “B5” based on the performance signal (Step S521). The control unit 301 determines that the performance signal is a vocalization start instruction (Step S522: YES) and determines whether or not either tc-ts≤tₜₕ or M(i)=M(1) is satisfied (Step S523). Here, since tc−ts is shorter than the prescribed interval tₜₕ, it is determined that tc−ts≤tₜₕ is satisfied (Step S523: YES) and an instruction to generate an audio signal based on the vocalization of the character “n” at the pitch “A5” is output (Step S526). Here, the control unit 301 actually outputs an instruction to generate an audio signal to continue the vocalization of the immediately preceding character “n”. Therefore, in order to continue the vocalization of the character “n,” an audio signal based on the vocalization of “-”, which is a prolonged sound at the pitch “B5” is generated. The control unit 301 sets the count value tc to time is (Step S527), terminates the instruction process, and proceeds to the Step S403 shown in FIG. 4. In FIG. 11, the interval ton(3)-toff(3) is the period during which the audio signal based on the vocalization of the character “n” at the pitch “A5” is generated.

In this manner, in the sound generation process according to the present embodiment, if the time interval from the immediately preceding vocalization start instruction to the next vocalization start instruction is shorter than the prescribed time interval, the characters of the first lyrics data can be prevented from advancing.

In other words, if the time interval from the immediately preceding vocalization start instruction to the next vocalization start instruction is shorter than the prescribed time interval, the second vocalization start instruction satisfies the first condition. In this case, the control unit 301 outputs an instruction to generate an audio signal to continue the first vocalization corresponding to the start instruction of the first vocalization. For example, “-”, which is a prolonged sound at pitch “B5,” is assigned to the syllable note of the interval ton(3)-toff(3).

### MODIFIED EXAMPLES

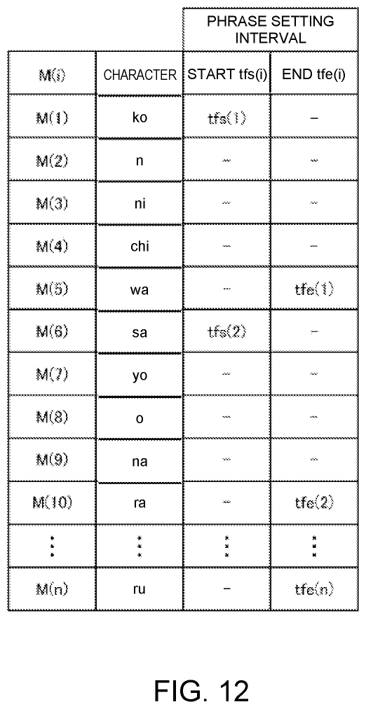

The embodiments of this disclosure were described above, but the embodiments of this disclosure can be modified in various forms, as described in the following. In addition, the embodiment described above and the modified examples that will now be described can be applied in combination with each other.
(1) In the foregoing embodiments, a case was described in which an audio signal based on one vocalization is generated per character, but the embodiments of this disclosure are not limited in this way. The case of generating an audio signal based on one vocalization per phrase will be described with reference to FIGS. 12-14.

Here, the first lyrics data stored in the storage unit 303 will be described with reference to FIG. 12. FIG. 12 is a diagram explaining the first lyrics data in an embodiment of this disclosure. The first lyrics data shown in FIG. 12 include a first phrase “ko” “n” “ni” “chi” “wa” and a second phrase “sa” “yo” “o” “na” “ra.” If the first phrase “ko” “n” “ni” “chi” “wa” is considered as a single vocalization, the stop time of the first vocalization corresponds to tfs(1), and the stop time corresponds to tfe(1). In addition, if the second phrase “sa” “yo” “o” “na” “ra” is considered as a single vocalization, the start time of the second vocalization corresponds to tfs(2) and the stop time corresponds to tfe(2).

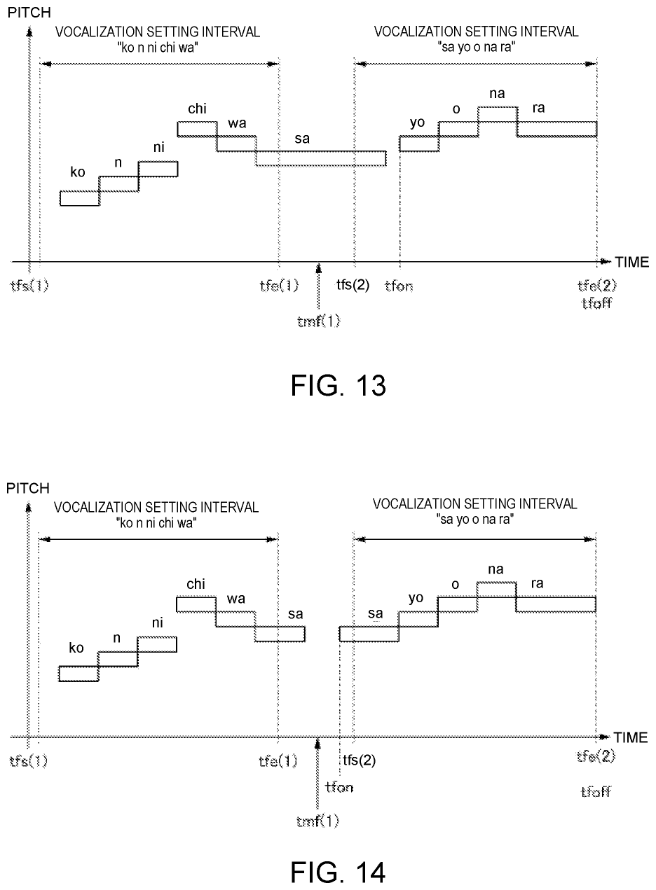

FIGS. 13 and 14 are diagrams showing the relationship between time and pitch in the sound generation process. FIGS. 13 and 14 indicate vocalization intervals defined by phrases. In FIGS. 13 and 14, the vocalization corresponding to the characters in a phrase can be advanced for each key depression or in accordance with an instruction process shown in the second embodiment. Between the first phrase and the second phrase, a center time tfm(1) between the stop time tfe(1) of the first phrase and the start time tfs(2) of the second phrase can be set in advance. The center time tfm(1) is obtained by calculating center time tfm(1)=(te(1)+ts(2))/2. The control unit 301 determines whether the acquisition time of the vocalization start instruction is before the center time tfm(1), in the same manner as in the first embodiment.

When it is determined that the vocalization start instruction is before the center time tfm(1), the control unit 301 outputs an instruction to the DSP to generate an audio signal based on the vocalization corresponding to the first (beginning) character of the first phrase. When it is then determined that the vocalization start instruction is before the center time tfm(1), the control unit 301 can output an instruction to the DSP to generate an audio signal based on the vocalization corresponding to the first (beginning) character of the second phrase.

When it is determined that the vocalization start instruction follows the center time tfm(1), the control unit 301 also determines whether the vocalization start instruction follows the start time tfs(2) of the second phrase. If it is determined that the vocalization start instruction follows the start time tfs(2) of the second phrase, the control unit 301 outputs an instruction to the DSP to generate an audio signal based on the vocalization corresponding to, from among the characters corresponding to the vocalizations of the second phrase, the character that has not yet been vocalized. Specifically, as shown in FIG. 13, a case is assumed in which audio signals are generated based on vocalizations corresponding to the characters “ko”, “n”, “ni”, “chi”, “wa”, and “sa” between the start time tfs(1) to the stop time tfe(1) of the first phrase. If a vocalization start instruction is acquired after the start time tfs(2) of the second phrase (time tfon), an audio signal is generated based on the vocalization corresponding to the character “yo” of the second phrase. If a vocalization stop instruction corresponding to the character “ra” is acquired at time tfoff, the control unit 301 outputs an instruction to the DSP to stop the generation of audio signals.

On the other hand, if it is determined that the vocalization start instruction precedes the start time tfs(2) of the second phrase, the control unit 301 generates an audio signal based on a vocalization corresponding to the first (beginning) character of the characters corresponding to the vocalization. Specifically, as shown in FIG. 14, a case is assumed in which an audio signals is generated based on vocalizations corresponding to the characters “ko”, “n”, “ni”, “chi”, “wa”, and “sa” between the start time tfs(1) to the stop time tfe(1) of the first phrase. If a vocalization start instruction is acquired before the start time tfe(2) of the second phrase (time tfon), an audio signal is generated based on the vocalization corresponding to the character “sa” of the second phrase. If a vocalization stop instruction corresponding to the character “ra” is acquired at time tfoff, the control unit 301 outputs an instruction to the DSP to stop the generation of the audio signal.

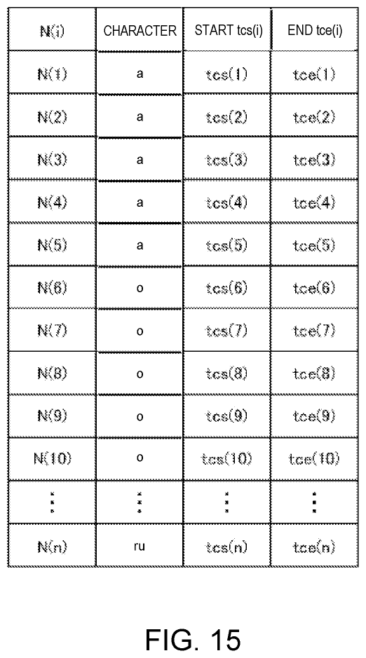

In the modified example (1), the first condition is a condition in which the time that the vocalization start instruction is acquired precedes the center time between the stop time of the first phrase and the start time of the second phrase. In addition, the second condition is a condition that the time that the vocalization start instruction was acquired follows the start time tfs(2) of the second vocalization. In other words, the second condition described above is satisfied when the acquisition time of the vocalization start instruction follows the start time of the second vocalization as defined in the first lyrics data.
(2) In the foregoing embodiments, a method for generating a synthesized singing sound in which the lead vocal part and the first lyrics data correspond to each other was explained, but this disclosure is not limited in this way. A case of generating a synthesized singing sound in which the chorus part and the second lyrics data correspond to each other will be described with reference to FIG. 15.

FIG. 15 is the second lyrics data corresponding to the chorus part. The second lyrics data also include text data in which a plurality of characters to be vocalized are arranged in chronological order. The second lyrics data include timing data that define the start and stop times of vocalization for each of a plurality of characters on a prescribed time axis.

As shown in FIG. 15, the second lyrics data include text data representing “a” “a” “a” “a” “a” “o” “o” “o” “o” “o.” In addition, the second lyrics data include timing data in which a vocalization start time is and stop time to are set for each character. N(i) is associated with each character, and the “i” (i=1-n) sets the order of the characters in the lyrics. For example, N(3) corresponds to the 3rd character in the lyrics. For example, in the case of N(3), “a,” the vocalization start time is time tcs(3) and the stop time is time tce(3). Each of the plurality of characters in the second lyrics data is associated with a setting interval defined by the start time and the stop time of vocalization on the prescribed time axis.

The vocalization interval defined in the first lyrics data as shown in FIG. 3 and the vocalization interval defined in the second lyrics data as shown in FIG. 15 overlap. That is, the start time and end time in N(1)-N(n) shown in FIG. 15 and the start time and end time in M(1)-M(n) shown in FIG. 3 coincide. In this case, the control unit 301 can output an instruction to the DSP to generate an audio signal based on vocalizations corresponding to characters of the chorus part instead of the lead vocal part. In addition, in the case that the vocalization interval defined in the first lyrics data and the vocalization interval defined in the second lyrics data overlap, the control unit 301 can change the first condition of the first embodiment to another condition. As another condition, the center time tm(q) between the vocalization stop time te(q) corresponding to the immediately preceding character M(q) and the vocalization start time ts(q+1) corresponding to the next character M(q+1) can be shifted forward or backward instead of residing at the center. For example, tm(q)=(te(q)+ts(q+1))×(⅓) or tm(q)=(te(q)+ts(q+1))×(⅔) can be set.

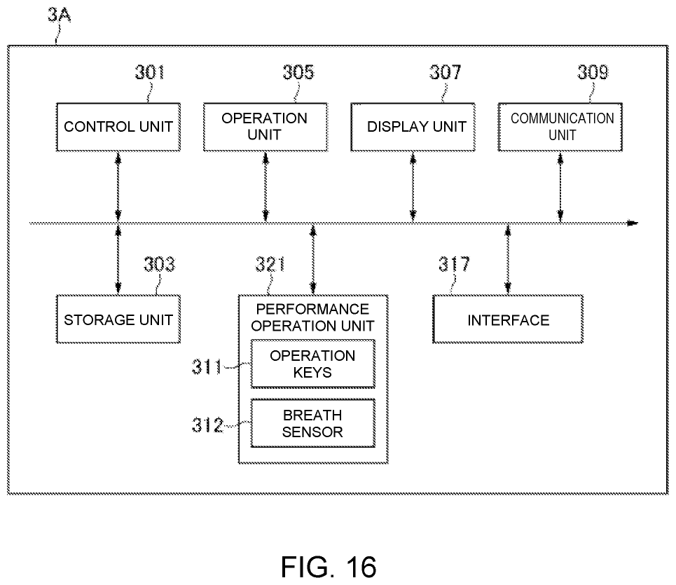

Moreover, the control can be as follows. In the first lyrics data, the control unit 301 identifies a setting interval to which the acquisition time of the vocalization start instruction belongs, or a setting interval that is closest to the acquisition time. If the second lyrics data include a setting interval that temporally coincides with the setting interval identified above, the control unit 301 then generates an audio signal based on a vocalization corresponding to a character that corresponds to the temporally coincident setting interval in the second lyrics data. That is, if the setting interval corresponding to the acquisition time of the vocalization start instruction is in both the first lyrics data and the second lyrics data, the vocalization of the second lyrics data is prioritized. Such a process can also be applied when the second lyrics data correspond to the first lyrics data only in some time regions. If the chorus part is also used, the third time described above can be shifted forward or backward with respect to the center time of the stop time te(q) and the start time ts(q+1).
(3) In the present embodiment, a case in which the electronic musical instrument 3 is an electronic keyboard device was described, but no limitation is imposed thereby. The electronic musical instrument 3 can be an electronic wind instrument. A case in which an electronic wind instrument is used as the electronic musical instrument 3 will be described below with reference to FIG. 16.

FIG. 16 is a hardware configuration when an electronic musical instrument 3A is an electronic wind instrument. In the case of an electronic wind instrument, the performance operation unit 321 includes operation keys (user operable keys) 311 and a breath sensor 312.

The electronic musical instrument 3A has a plurality of sound holes in the body of the instrument, a plurality of operation keys 311 that change the open/closed state of the sound holes, and the breath sensor 312. When a performer plays the plurality of operation keys 311, the open/closed states of the sound holes are changed, thereby outputting sound with a prescribed tone. A mouthpiece is attached to the body of the instrument, and the breath sensor 312 is provided inside the instrument body in the vicinity of the mouthpiece. The breath sensor 312 is a pressure sensor that detects the blowing pressure of breath blown in by the user (performer) through the mouthpiece. The breath sensor 312 detects the presence or absence of the blowing in of the breath as well as, at least when the electronic musical instrument 3A is played, the intensity and speed (momentum) of the blowing pressure. The volume of the vocalization is determined in accordance with the magnitude of the pressure detected by the breath sensor 312. In the present modified example, the magnitude of the pressure detected by the breath sensor 312 is treated as volume information. If the breath sensor 312 detects a prescribed magnitude of pressure, it is treated as a vocalization start instruction. If the detected magnitude of pressure is less than the prescribed pressure, it is not treated as a vocalization start instruction.

In the electronic wind instrument, as described in FIGS. 10 and 11, there are cases in which the first time interval, from the start instruction of the first vocalization to the start instruction of the second vocalization, is less than a prescribed time interval and can be detected as a transitional tone specific to wind instruments. In the sound generation process according to the embodiment of this disclosure, the control unit 301 outputs an instruction to generate an audio signal so as to continue the first vocalization, rather than the second vocalization, even if the first time interval is greater than or equal to the prescribed time interval. Accordingly, even if such a transitional tone occurs in the middle of the performance, it is possible to prevent the position of the lyrics from advancing ahead of the performance; thus, a natural synthesized singing sound can be generated.
(4) In the first embodiment, a case was described in which the center time tm(q)=(te(q)+ts(q+1))/2, but no limitation is imposed thereby. It can be shifted forward or backward rather than residing at the center. For example, tm(q)=(te(q)+ts(q+1))×(⅓) or tm(q)=(te(q)+ts(q+1))×(⅔) can be set.
(5) In the second embodiment, a case was described in which the first condition includes the condition that the volume is lower than a prescribed volume, but the embodiment of this disclosure is not limited in this way. The first condition can omit Step S524 in FIG. 10, and can simply be a condition pertaining to whether or not either tc-ts≤tₜₕ or M(i)=M(1) in Step S523 is satisfied.

This disclosure was described above based on preferred embodiments, but this disclosure is not limited to the above-described embodiments, and includes various embodiments that do not deviate from the scope of the invention. Some of the above-described embodiments can be appropriately combined.

The performance signal can be acquired from the outside via communication. Therefore, it is not essential to provide the performance operation unit 321, and it is not essential for the sound generation device to have the function and form of a musical instrument.

A storage medium that stores a control program represented by software for achieving this disclosure can be read into the present device to achieve the same effects of this disclosure, in which case the program code read from the storage medium realizes the novel functions of this disclosure, so that the non-transitory, computer-readable storage medium that stores the program code constitutes this disclosure. In addition, the program code can be supplied via a transmission medium, or the like, in which case the program code itself constitutes this disclosure. The storage medium in these cases can be, in addition to ROM, a floppy disk, a hard disk, an optical disc, a magneto-optical disk, a CD-ROM, a CD-R, a magnetic tape, a non-volatile memory card, or the like. The non-transitory, computer-readable storage medium includes storage media that retain programs for a set period of time, such as volatile memory (for example, DRAM (Dynamic Random Access Memory)) inside a computer system that constitutes a server or a client, when the program is transmitted via a network such as the Internet or a communication line, such as a telephone line.

### Effects

By this disclosure, it is possible to generate natural synthesized singing sounds when singing sounds are generated in a real-time performance.

What is claimed is:

1. A sound generation device comprising:
an electronic controller including at least one processor, the electronic controller being configured to execute a plurality of modules including
a first acquisition module configured to acquire first lyrics data in which a plurality of characters to be vocalized are arranged in a time series and that include at least a first character and a second character that follows the first character,
a second acquisition module configured to acquire a vocalization start instruction, and
a control module configured to, in response to the second acquisition module acquiring the vocalization start instruction,
output an instruction to generate an audio signal based on a first vocalization corresponding to the first character in the first lyrics data, in response to the vocalization start instruction satisfying a first condition, and
output an instruction to generate an audio signal based on a second vocalization corresponding to the second character in the first lyrics data, in response to the vocalization start instruction not satisfying the first condition.

2. The sound generation device according to claim 1, wherein
the first lyrics data define a start time and a stop time for each of the plurality of characters on a prescribed time axis, and
the vocalization start instruction for which an acquisition time precedes a third time between a first time at which the first vocalization is stopped and a second time at which the second vocalization is started on the prescribed time axis satisfies the first condition.

3. The sound generation device according to claim 2, wherein
the third time is a center time between the first time and the second time.

4. The sound generation device according to claim 2, wherein
each of the first vocalization and the second vocalization corresponds to one character.

5. The sound generation device according to claim 2, wherein
the first vocalization includes vocalizations corresponding to a plurality of characters that include the first character,
the second vocalization includes vocalizations corresponding to a plurality of characters that include the second character,
the first time corresponds to a time at which a vocalization of a last character, from among the plurality of characters corresponding to the first vocalization, is stopped, and
the second time corresponds to a time at which a vocalization of a beginning character, from among the plurality of characters corresponding to the second vocalization, is started.

6. The sound generation device according to claim 5, wherein
the control module is configured to output the instruction to generate the audio signal based on the beginning character of the second vocalization following the vocalization of the last character in the first vocalization, and
to output the instruction to generate the audio signal based on the second vocalization, in response to the vocalization start instruction further satisfying a second condition, the control module is configured to output the instruction to generate the audio signal based on a vocalization corresponding to, from among the characters corresponding to the second vocalization, a character that has not yet been vocalized.

7. The sound generation device according to claim 6, wherein
the vocalization start instruction for which the acquisition time follows a start time of the second vocalization defined in the first lyrics data satisfies the second condition.

8. The sound generation device according to claim 1, wherein
the plurality of characters in the first lyrics data are associated with a plurality of setting intervals respectively, each the plurality of characters is defined by a start time and a stop time of vocalization on a prescribed time axis, and
the control module is configured to identify, as an identified setting interval, one of the plurality of setting intervals to which an acquisition time of the vocalization start instruction belongs, or one of the plurality of setting intervals that is closest to the acquisition time on the prescribed time axis among the plurality of setting intervals, and output the instruction to generate the audio signal based on a vocalization corresponding to a character corresponding to the identified setting interval, as the audio signal based on the first vocalization or the audio signal based on the second vocalization.

9. The sound generation device according to claim 8, wherein
the first acquisition module is configured to acquire second lyrics data in which a plurality of characters to be vocalized are arranged in time series, and that define a start time and a stop time of vocalization for each of the plurality of characters on the prescribed time axis,
each of the plurality of characters in the second lyrics data is associated with a setting interval defined by the start time and the stop time of vocalization on the prescribed time axis, and
as the second lyrics data include a temporally coincident setting interval that temporally coincides with the identified setting interval, the control module is configured to output an instruction to generate an audio signal based on a vocalization corresponding to a character that corresponds to the temporally coincident setting interval in the second lyrics data, instead of the audio signal based on the first vocalization or the second vocalization.

10. The sound generation device according to claim 1, wherein
in the first lyrics data, a vocalization order of the plurality of characters is set, and
in response to the second acquisition module acquiring the vocalization start instruction of the second vocalization after the vocalization start instruction of the first vocalization, as a first time interval from the vocalization start instruction of the first vocalization to the vocalization start instruction of the second vocalization is shorter than a prescribed time interval, the control module is configured to determine that the vocalization start instruction of the second vocalization satisfies the first condition, and output an instruction to generate an audio signal so as to continue the first vocalization corresponding to the vocalization start instruction of the first vocalization.

11. The sound generation device according to claim 10, wherein,
as volume information acquired from a performance operation unit at an acquisition time of the vocalization start instruction of the second vocalization is less than a prescribed value, the control unit module is configured to output the instruction to generate the audio signal so as to continue the first vocalization, rather than the second vocalization, even if the first time interval is greater than or equal to the prescribed time interval.

12. The sound generation device according to claim 11, wherein
the performance operation unit includes a breath sensor configured to detect pressure change,
the second acquisition module is configured to acquire the vocalization start instruction of the first vocalization and the vocalization start instruction of the second vocalization based on the pressure change detected by the breath sensor.

13. The sound generation device according to claim 1, wherein,
to generate the audio signal based on the first vocalization or the second vocalization, the control unit module is configured to control a vocalization included in the audio signal to have a pitch in accordance with a pitch instruction from a performance operation unit.

14. An electronic musical instrument comprising:
the sound generation device according to claim 1; and
a performance operation unit to which a user inputs the vocalization start instruction.

15. A control method for a sound generation device realized by a computer, the control method comprising:
acquiring first lyrics data in which a plurality of characters to be vocalized are arranged in a time series and that include at least a first character and a second character that follows the first character;
acquiring a vocalization start instruction; and
outputting an instruction to generate an audio signal in response to the acquiring of the vocalization start instruction, the outputting of the instruction including
outputting the instruction to generate the audio signal based on a first vocalization corresponding to the first character in the first lyrics data in response to the vocalization start instruction satisfying a first condition, and
outputting the instruction to generate the audio signal based on a second vocalization corresponding to the second character in the first lyrics data in response to the vocalization start instruction not satisfying the first condition.

16. A non-transitory computer-readable medium storing a program that causes a computer to execute a control method for a sound generation device, the control method comprising:
acquiring first lyrics data in which a plurality of characters to be vocalized are arranged in a time series and that include at least a first character and a second character that follows the first character;
acquiring a vocalization start instruction; and
outputting an instruction to generate an audio signal in response to the acquiring of the vocalization start instruction, the outputting of the instruction including
outputting the instruction to generate the audio signal based on a first vocalization corresponding to the first character in the first lyrics data in response to the vocalization start instruction satisfying a first condition, and
outputting the instruction to generate the audio signal based on a second vocalization corresponding to the second character in the first lyrics data in response to the vocalization start instruction not satisfying the first condition.
